(19) United States
(12) Patent Application Publication
(10) Pub. No.: US 2008/0135141 A1
(43) Pub. Date: Jun. 12, 2008

(54) METHOD OF MANUFACTURING ELECTRICAL DISCHARGE ELECTRODE

(75) Inventor: Masayoshi FUJITA, Tokai-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/953,389

(22) Filed: Dec. 10, 2007

(30) Foreign Application Priority Data
Dec. 11, 2006 (JP) 2006-333013

(51) Int. Cl. B23H 1/04; C22F 1/02

(52) U.S. Cl. 148/712; 219/69.12; 148/708

(57) ABSTRACT

A method of manufacturing an electrical discharge electrode is disclosed as comprising an electrode outline body forming step of conducting a given mechanical machining on an electrode material to form an electrode outline body, an electrode outline body annealing step of annealing the electrode outline body at least one time for removing residual stress therefrom, and an electrode segment forming step of removing a surrounding wall portion from an electrical discharge portion of the electrode outline body by wire electrical discharging to form an electrode segment portion with a given wall thickness and shape.

### CROSS REFERENCE TO RELATED APPLICATIONS

This application is related to Japanese Patent Application No. 2006-333013, filed on Dec. 11, 2006, the content of which is hereby incorporated by reference.

### BACKGROUND OF THE INVENTION

1. Technical Field of the Invention

The present invention relates to a method of manufacturing an electrical discharge electrode to be used in manufacturing a honeycomb structure molding die.

2. Description of the Related Art

Attempts have heretofore been made for an automobile or the like to be equipped with all exhaust gas purifying converter. The exhaust gas purifying converter includes a monolith type honeycomb structure body that is used as a catalyst carrier. The honeycomb structure body is formed by squeezing and molding raw material with the use of a molding die. In recent years, for the purpose of increasing the performance of the exhaust gas purifying converter, the honeycomb structure body has multiple cells each having an extremely thin partition wall. This allows the honeycomb structure body to reliably purify exhaust gases from the beginning of engine startup of the automobile. Accordingly, a need has arisen for the molding die to have slit recesses each with a clearance distance less than 100 microns for squeezing raw material to form the honeycomb structure body with such thin partition walls.

U.S. Pat. No. 6,732,621 discloses a method of manufacturing a molding die for a honeycomb structure body. In such a method, the molding, die has slit recesses that are cut by grinding with the use of a thin-bladed grinding wheel. Each of the slit recesses, having a width of 105 to 110 μm (microns), can be formed by grinding with the use of a thin-bladed grinding wheel or by electrical discharge processing.

In manufacturing the molding die slit recesses each with a width less than 100 microns in a fine clearance, electrical discharge processing can also be employed. An electrode for use in performing such electrical discharge processing has a structure including an electrical discharge section, to initiate electrical discharge for forming a fine-clearance slit recess on the molding die, and which has a thickness needed to be further less than a width of the fine-clearance slit recess of the molding die. With the honeycomb structure body's cell walls each formed so thinly, the width of the molding die slit recesses of the order of, for instance, 90 microns. In this case, the electrode needs to have all electrical discharge section whose thickness is about 45 microns. That is, the electrical discharge section of the electrode is extremely thin.

In manufacturing the electrical discharge electrode, the electrode material is cut into an electrode outline body by a mechanical machining step. Thereafter, the electrode section of the electrode outline body is finished by wire-electrical discharge into a profile with the required shape and thickness. However, residual stress occurs inside the electrode outline body when subjected to mechanical machining and it is difficult to avoid the occurrence of such residual stress.

Therefore, while the electrical discharge section is finished by wire-electrical discharge, residual stress occurs inside the electrode outline body and causes the electrical discharge section to be deformed or ruptured due to its extreme thinness.

### SUMMARY OF THE INVENTION

The present invention has been completed with a view to addressing the above issue and has an object to provide a method of manufacturing an electrical discharge electrode in which a step of removing residual stress, caused by mechanically machining the electrical discharge section, is additionally provided to be conducted before wire-electrical discharge is initiated on the electrode section thereby preventing damage to the electrical discharge section.

To achieve the above object, one aspect of the present invention provides a method of manufacturing an electrical discharge electrode, comprising an electrode outline body forming step of conducting a given mechanical machining on the electrode material to form an electrode outline body, an electrode outline body annealing step of annealing the electrode outline body for removing residual stress therefrom, and an electrode segment forming step of removing a surrounding wall portion from the electrical discharge portion of the electrode outline body by wire electrical discharging to form an electrode segment portion with a given wall thickness and shape.

With such a method, the presence of the electrode outline body annealing step enables removal of residual stress resulting from the mechanical machining of the electrode outline body, thereby making it possible to prevent damage to the electrode segment portion encountered in the related art. Accordingly, even if the electrode segment portion has extremely thin walls, it becomes possible to obtain an electrical discharge electrode with high accuracy.

With the method of manufacturing an electrical discharge electrode, the electrode outline body forming step may preferably comprise an electrode outline base body forming step of conducting the given mechanical machining on the electrode material to form an electrode outline base body, and a start point hole forming step of forming a start point hole in the electrical discharge portion of the electrode outline base body, wherein the electrode outline body annealing step comprises steps of annealing the electrode outline body first and second times after the electrode outline base body forming step and the start point hole forming step, respectively.

With such a method, the electrode outline body annealing step allows the electrode outline body to be annealed after the completions of the electrode outline base body forming step and the start point hole forming step, respectively, enabling a removal of residual stress occurring in respective processing steps.

With the method of manufacturing an electrical discharge electrode, the electrode outline body annealing step may be preferably conducted in a vacuum at a temperature ranging from 450 to 750° C. for 30 to 120 minutes.

With such a method, the annealing, treatment of the electrode outline body can be adequately conducted in a highly reliable manner, while reliably enabling removal of residual stress.

With the method of manufacturing an electrical discharge electrode, the electrode material may be preferably copper tungsten, wherein the electrode outline body annealing step is conducted in a vacuum at a temperature of 700° C. for 60 minutes.

With such a method, the use of copper tungsten electrode material enables less wear of the electrode. In addition, the annealing treatment conditions are set to the parameters suited for copper tungsten. This enables the removal of residual stress from copper tungsten in a highly reliable manner.

With the method of manufacturing an electrical discharge electrode, the electrode outline body annealing step may preferably comprise a quenching step of performing quenching under a nitrogen gas atmosphere after the annealing has been completed.

With such a method, the electrode outline body can be cooled to a normal temperature in a short period of time without causing oxidation of the electrode outline body. This enables a reduction of an annealing treatment time.

With this method of manufacturing an electrical discharge electrode, the nitrogen may be preferably liquid nitrogen that is evaporated to form nitrogen gas to be blown into the vacuum for quenching.

With such a method, gasifying liquid nitrogen and blowing low temperature nitrogen gas enables the electrode outline body to be cooled to a normal temperature within a shortened time period, enabling annealing treatment to be efficiently performed without causing a change in the annealing environment.

This method of manufacturing an electrical discharge electrode may be preferably applied to a honeycomb structure molding-die manufacturing electrode.

With such a method, the honeycomb structure molding-die can be processed to have slit recesses that need to be formed the fine clearances, respectively.

Another aspect of the present invention provides a method of manufacturing an electrical discharge electrode for use in manufacturing a honeycomb structure molding die by electrical discharge, comprising mechanically machining an electrode material to form an electrode outline body having an electrical discharge portion, forming a plurality of start point holes with surrounding wall portions in the electrical discharge portion of the electrode outline body at equidistantly spaced positions, annealing the electrode outline body to remove residual stress therefrom, and forming electrode segment portions on the electrical discharge portion of the electrode outline body in a honeycomb pattern each with a given wall thickness and shape upon removing the surrounding wall portions from the start point holes of the electrical discharge portion by wire electrical discharge machining.

With such a manufacturing method, annealing the electrode outline body annealing enables residual stress, resulting from the mechanical machining of the electrode outline body, to be removed from the electrode outline body. This makes it possible to prevent damage to the electrode segment portion encountered in the related all. Accordingly, even if the electrode segment portion has extremely thin walls, it becomes possible to obtain an electrical discharge electrode with high accuracy.

### BRIEF DESCRIPTION OF THE DRAWINGS

FIG. 1 is a plan view of an electrode outline base body formed by an electrode manufacturing method according to the present invention.

FIG. 2 is a cross sectional view taken on line A-A of FIG. 1.

FIG. 3 is a plan view of the electrode outline base body in a situation in which the electrode outline base body of FIG. 1 is subjected to mechanical machining.

FIG. 4 is an enlarged plan view showing the circled area B of FIG. 3 at an enlarged scale.

FIG. 5 is an enlarged plan view showing how a start point hole of the electrode outline body, shown in FIG. 4, is subjected to wire-electric discharging.

FIG. 6 is an enlarged plan view showing an electrical discharge section formed by the electrode manufacturing method of the present invention.

FIG. 7 is a plan view showing an electrical discharge electrode manufactured by the electrode manufacturing method of the present invention.

FIG. 8 is a cross sectional view taken on line C-C of FIG. 7.

### DETAILED DESCRIPTION OF PREFERRED EMBODIMENTS

Now, a method of manufacturing an electrical discharge electrode according to the present invention will be described below in detail with reference to the accompanying drawings. However, the present invention is construed not to be limited to such an embodiment described below and technical concepts of the present invention may be implemented in combination with other known technologies or other technology having functions equivalent to such known technologies.

The electrical discharge electrode, manufactured according to the present invention, will be described below with reference to an example of an electrical discharge electrode for manufacturing an extrusion die that molds a honeycomb structure body for use in an exhaust gas purifying device for a motor vehicle. However, the electrical discharge electrode of the present invention is not limited to the electrical discharge electrode of such a structure mentioned above.

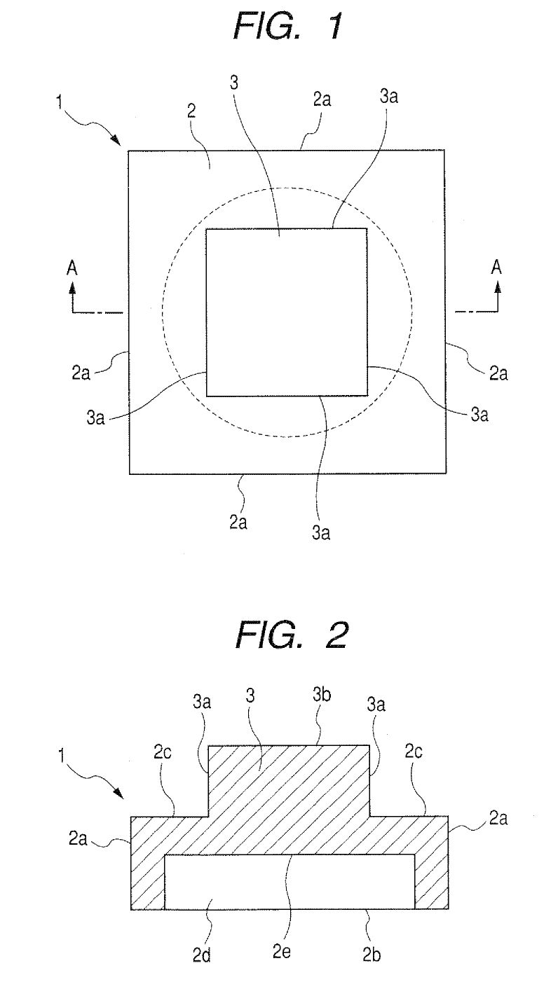

As shown in FIGS. 1 and 2, first, copper tungsten material, serving as an electrode material, is mechanically machined in a given profile, thereby obtaining an electrode outline base body 1. The electrode outline base body 1 includes an electrode mount section (shank) 2 and an electrical discharge section 3. The electrode mount section 2 is mortised to form a mortised hole 2d, facilitating mortising work to form electrode segments in a honeycomb structure using wire-discharge machining that will be described below in detail. Although the present embodiment of the present invention will be described below with reference to mortising work performed for forming the mortised hole 2d in a circular shape in cross section as shown in FIGS. 1 and 2, the mortised hole 2d may be machined in a square shape in cross section. In addition, the electrode mount section 2 has four side surfaces 2a, a bottom surface 2b and an upper surface 2c. The electrical discharge section 3 has four side surfaces 3a and a top surface 3b. All of these surfaces of the electrode mount section 2 and electrical discharge section 3 are formed by mechanically machining such as milling or the like.

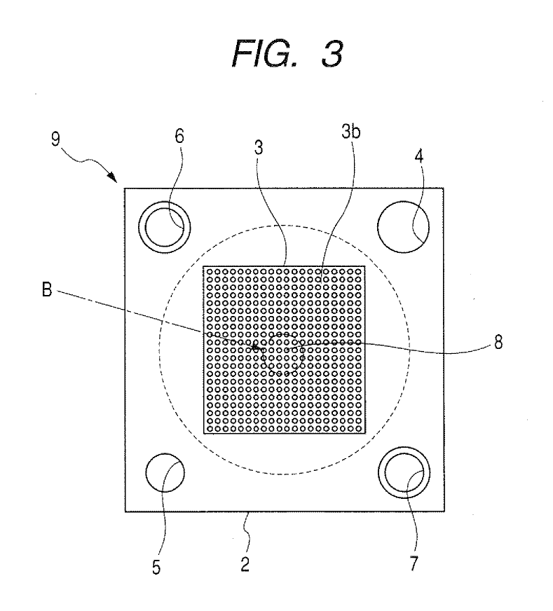

As shown in FIG. 3, next, reference holes 4, 5 are formed in the electrode mount section 2 of the electrode outline base body 1 on a first diagonal line by mechanical machining and serve as benchmarks for various processing steps to be executed in a subsequent process. Mounting threaded bores 6, 7 are formed in the electrode mount section 2 on a second diagonal line perpendicular to the first diagonal line by mechanical machining (tapping) and mounted on an electrical discharge machine (not shown). The reference holes 4, 5 and threaded bores 6, 7 are located at given positions on the same diametric positions with the center of the electrode outline base body 1. In addition, the reference holes 4, 5 are provisionally machined and subjected to finishing work in a subsequent step. The manufacturing method of the present invention includes the above-described mechanical machining steps, which will be referred to as “an electrode outline base body forming step”.

Subsequently, a first round of annealing treatment is conducted on the electrode outline base body 1 obtained by mechanical machining conducted as set forth above. This treatment is conducted for removing residual stress from the internal area of the electrode outline base body 1. As will be described below, with the electrical discharge electrode for the honeycomb structure molding die of the present embodiment, the electrode segments of the electrical discharge section 3 include extremely thin sections, respectively. Therefore, it is extremely important to remove residual stress from the electrode segments during machining thereof and removal of residual stress forms a feature of the manufacturing method of the present invention.

The electrode outline base body 1 is subjected to annealing treatment in a vacuum furnace under conditions with the temperature at 450 to 750° C. for 30 to 120 minutes. When using copper tungsten material as the electrode material, a treatment temperature of 700° C. and a treatment time of 60 minutes are employed as the most preferable treatment conditions. By conducting annealing treatment at 700° C. for 60 minutes, annealing treatment can be conducted on copper tungsten material in an optimum mode, making it possible to reliably conduct annealing treatment while reliably removing residual stress from the inner area of the electrode outline base body 1. Moreover, with the electrode material made of copper tungsten material, the electrode has less wear than that of an electrode made of pure copper or the like.

Upon completing annealing treatment, liquid nitrogen is evaporated and the resulting low-temperature nitrogen gas is injected into the vacuum furnace. Using this flow of cold nitrogen gas as a cooling medium enables the electrode outline base body 1 to be cooled to a normal temperature within a shortened period of time. Thus, no need arises for the electrode outline base body 1 to be translocated to a cooling facility in a separate place. Thus, annealing treatment can be efficiently conducted on the electrode outline base body 1 without changing the environment tinder which annealing treatment is conducted. Injecting low-temperature nitrogen gas to the furnace enables the furnace to be rapidly cooled, thereby causing the electrode outline base body 1 to be returned to a normal temperature. Further, the electrode outline base body 1 is quenched under a nitrogen gas atmosphere upon gasifying liquid nitrogen into nitrogen gas and injecting the same into the furnace. Thus, no oxidation of the electrode outline base body 1 is induced. In addition, in forming the nitrogen gas atmosphere, gasifying liquid nitrogen results in smaller storage requirements for nitrogen than that of nitrogen stored in a gas state.

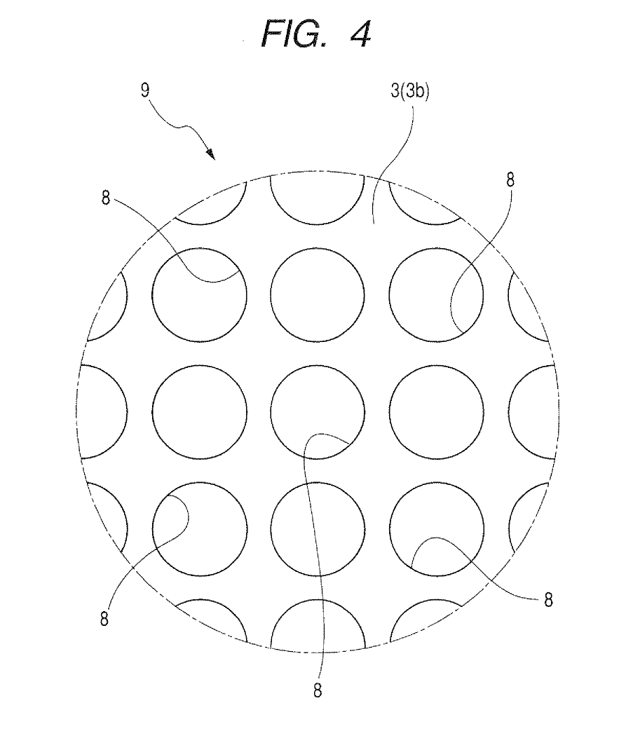

Subsequently, start point holes 8 are formed on the top surface 3b of the electrical discharge section 3 at equidistantly spaced positions in a manner as shown in FIG. 3. The start point holes 8, surrounded in a circled area B of FIG. 3, are shown in an enlarged scale in FIG. 4. A given number of start point holes 8 are formed in a given area as shown in FIG. 4 with reference to the benchmarks provided by the reference holes 4, 5. With the present embodiment, the start point holes 8 are formed at the equidistantly spaced positions in lateral and vertical directions. The start point holes 8 serve as pilot holes for forming spaces (corresponding to respective compartment spaces of a honeycomb compact body) surrounded with the electrode segments machined by wire-discharge processing as will be described later.

Further, mechanical machining such as a drilling step is conducted to form the start point holes 8 with a drilling angle of 130°, after which further drilling is conducted to form holes each of the required depth and diameter. Such a process is conducted on the ceiling surface 2e, opposite to the top surface 3b of the electrical discharge section, of the mortised hole 2d at the same positions as the start point holes 8 formed on the top surface 3b of the electrical discharge section 3. This allows the start point holes 8 to become through-holes, respectively.

With the present embodiment, the drill has an outer diameter of 0.9 mm for perforating the start point holes 8 each with a diameter of nearly 0.9 mm. A perforation machining process for forming the start point holes 8 subsequent to the first round of annealing treatment is herein referred to as “a starter point hole forming step”. With the present embodiment, the electrode outline base body forming step, starting from the step of preparing electrode material to the step of wire-discharge processing, and the mechanical machining step for forming the start point holes are hereinafter referred to as “an electrode outline body forming step for forming an electrode outline body 9”.

Next, after the start point holes 8 have been mechanically machined, a second round of annealing treatment is conducted for removing residual stress from the inside of the electrode outline body 9 resulting from the step of mechanically machining the start point holes 8. The second round of annealing treatment is conducted under the same annealing and quenching condition as those of the first round of annealing treatment. Details of the conditions in the second round of annealing and quenching treatment will be omitted herein.

Subsequently, the electrode outline body 9 (having the same outer shape as that of the electrode base body 1 shown in FIGS. 1 and 2) has a top surface (corresponding TS to the top surface 3b of the electrical discharge section 3 shown in FIG. 2) that is subjected to a grinding process. Then, with such a top surface treated as a reference surface, a bottom surface (corresponding to the bottom surface 2b of the electrode mount section 2 shown in FIG. 2) is ground, while grinding two side surfaces (corresponding to the side surfaces 2a and 2a shown in FIG. 1), intersecting with each other, of the electrode outline body 9 after which with such ground two side surfaces treated as reference surfaces, the opposing two side surfaces are ground. Since these grinding processes are carried out with a smaller amount of grinding allowance, almost no residual stress occurs in the electrode outline body 9. Thereafter, the reference holes 4, 5 (see FIG. 3) are finished with high precision using the electrical discharge processing.

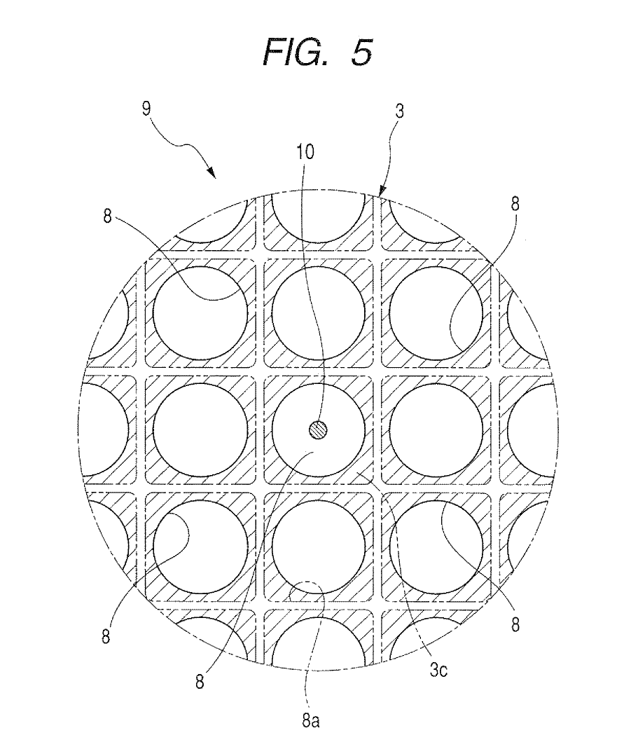

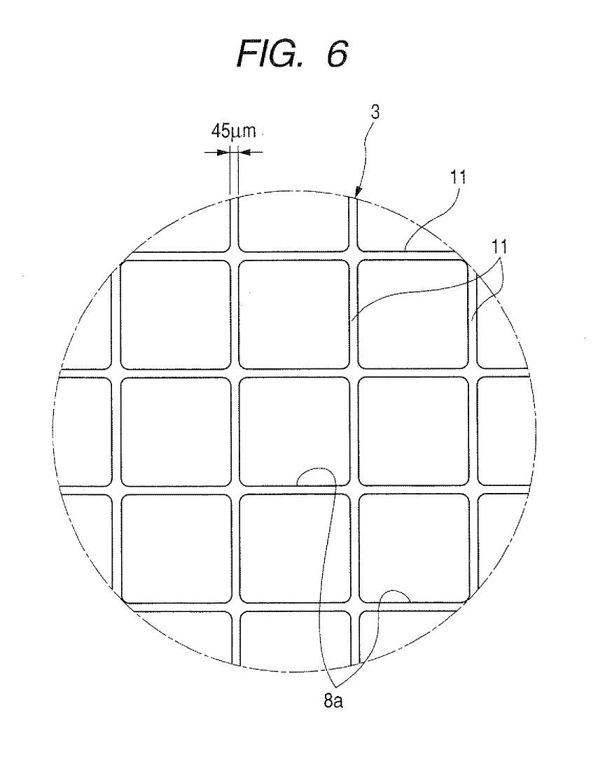

As shown in FIG. 5, passing an electrical discharge wire electrode 10 (with a diameter of 0.2 mm) through the start point hole 8 and conducting wire-electrical discharge machining allows a surrounding wall portion 3c (indicated by a hatched area) of the electrical discharge section 3 to be progressively mortised or removed, thereby forming an airspace (cell) in a given shape to form the electrode segments 11 as shown in FIG. 6. Although the present embodiment has been described with reference to the mortised airspace (representing a compartment, surrounded by the electrode segments 11, which corresponds to a cell of a honeycomb structure body and is wider than the cell) that is formed in a square shape, the mortised airspace may be formed in a polygonal or other shape. Moreover, with the present embodiment, the electrode segment portions 11 are made with an extremely thin wall of the order of approximately 45 microns thick. Conducting such wire-electrical discharging allows the desired number of compartments (cells) and electrode segment portions 11 to be formed. Also, the wire-electrical discharging is a normal machining process that is conducted in oil.

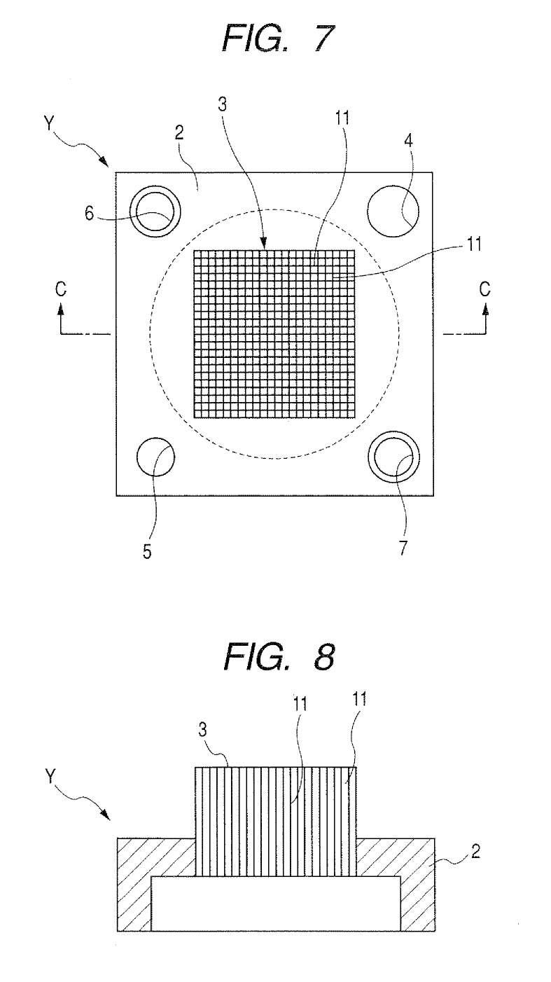

The electrode segment portions 11 are formed with a thickness of the order of approximately 45 microns by wire-electrical discharging. In the related art electrode manufacturing process, no annealing treatment has been conducted during the process of machining the relevant electrode segment portion. This causes deformation to occur in the electrode segment portion due to the presence of residual stress, causing damage to the relevant electrode segment portion. On the contrary, with the electrode manufacturing method of the present invention, the annealing treatment is conducted before the step of machining the electrode segment portion to remove residual stress caused by the mechanical machining step. Thus, no deformation and damage due to residual stress occur, thereby enabling the electrode segment portion 11 to be formed with a high accuracy. Upon completion of the above-described steps, an electrical discharge electrode Y is completely formed in the final shape as shown in FIGS. 7 and 8.

The resulting electrode Y is mounted on an electrical discharge machine (not shown) and a given step of electrical discharge processing is carried out to form slit recesses (not shown) in a honeycomb structure forming die, serving as a machined object, thereby obtaining an extrusion die. The method of using such an electrode Y to perform the electrical discharge processing of the honeycomb structure forming die includes the same steps as those normally conducted. There has been increasing demand for a honeycomb structure body to have a cell wall that is extremely thin. To comply with such a requirement, a need arises for an extrusion (forming) die to have slit recesses. Each of these slit recesses needs to be machined with a minimal clearance. The electrode Y, manufactured by the method of the present invention, can manufacture the extrusion die at the desired highest quality. That is, the method of manufacturing the electrode according to the present invention is particularly suited to an electrical discharge electrode for fabricating a honeycomb structure molding die having slit recesses, with minimal clearances, which can be formed at high precision.

Further; while the present invention has been described with reference to an electrode made of copper tungsten, the electrode may be made of pure iron or other material. However, in view of wear resistance of the electrode, the electrode should be preferably made of copper tungsten. Furthermore, the annealing treatment may be conducted under various conditions depending on the material of the electrode. Moreover, the electrode outline body 9 (inclusive of the electrode base body 1) may be subjected to not only the mechanical machining steps as set forth above but also other required mechanical machining. Although the electrode outline body 9 has been described above with reference to the process in which the annealing treatment is conducted on the electrode outline body 9 one time after the electrode outline base body forming step and another one time after the start point hole forming step, the present invention is not limited to such a process. That is, depending on the mechanical machining process, the annealing steps may be conducted multiple times for various forming steps. It is essential for residual stress, caused by the mechanical machining step, to be removed from the electrode outline body 9 before the wire-electrical discharging being executed on the electrode outline body 9.

While the specific embodiment of the present invention has been described in detail, it will be appreciated by those skilled in the art that various modifications and alternatives to those details could be developed in light of the overall teachings of the disclosure. Accordingly, the particular arrangement disclosed is meant to be illustrative only and not limited to the scope of the present invention, which is to be given the full breadth of the following claims and all equivalents thereof.

What is claimed is:

1. A method of manufacturing an electrical discharge electrode, comprising:
an electrode outline body forming step of conducting a given mechanical machining on an electrode material to form an electrode outline body;
an electrode outline body annealing step of annealing the electrode outline body for removing residual stress therefrom; and
an electrode segment forming step of removing a surrounding wall portion from an electrical discharge portion of the electrode outline body by wire electrical discharging to form an electrode segment portion with a given wall thickness and shape.

2. The method of manufacturing an electrical discharge electrode according to claim 1, wherein:
the electrode outline body forming step comprises an electrode outline base body forming step of conducting the given mechanical machining oil the electrode material to form an electrode outline base body having the electrical discharge portion, and a start point hole forming step of forming a start point hole in the electrical discharge portion of the electrode outline base body;
wherein the electrode outline body annealing step comprises steps of annealing the electrode outline body first and second times after the electrode outline base body forming step and the start point hole forming step, respectively.

3. The method of manufacturing, an electrical discharge electrode according to claim 1, wherein:
the electrode outline body annealing step is conducted in a vacuum at a temperature ranging from 450 to 750° C. for 30 to 120 minutes.

4. The method of manufacturing an electrical discharge electrode according to claim 3, wherein:
the electrode material is copper tungsten;
wherein the electrode outline body annealing step is conducted in the vacuum at a temperature of 700° C. for 60 minutes.

5. The method of manufacturing an electrical discharge electrode according to claim 3, wherein:
the electrode outline body annealing step comprises a quenching step of performing a quenching under a nitrogen gas atmosphere after the annealing has been completed.

6. The method of manufacturing an electrical discharge electrode according to claim 5, wherein:
the nitrogen is liquid nitrogen evaporated into nitrogen gas which is brown into the vacuum for quenching.

7. The method of manufacturing an electrical discharge electrode according to claim 1, wherein:
the method of manufacturing an electrical discharge electrode is applied to a honeycomb structure molding-die manufacturing electrode.

8. A method of manufacturing an electrical discharge electrode for use in manufacturing a honeycomb structure molding die by electrical discharge, comprising:
mechanically machining an electrode material to form an electrode outline body having an electrical discharge portion;
forming a plurality of start point holes with surrounding wall portions in the electrical discharge portion of the electrode outline body at equidistantly spaced positions, respectively;
annealing the electrode outline body to remove residual stress therefrom; and
forming electrode segment portions on the electrical discharge portion of the electrode outline body in a honeycomb pattern each with a given wall thickness and shape upon removing the surrounding wall portions from the start point holes of the electrical discharge portion, respectively, by wire electrical discharge.

9. The method of manufacturing an electrical discharge electrode according to claim 8, wherein:
the step of mechanically machining the electrode material comprises forming an electrode outline base body having the electrical discharge portion by mechanical machining, and forming the start point holes in the electrical discharge portion of the electrode outline base body;
wherein the step of annealing the electrode outline body comprises steps of annealing the electrode outline body first and second times after the step of forming the electrode outline base body and the step of forming the start point holes, respectively.

10. The method of manufacturing an electrical discharge electrode according to claim 8, wherein:
the step of annealing the electrode outline body is conducted in a vacuum at a temperature ranging from 450 to 750° C. for 30 to 120 minutes.

11. The method of manufacturing an electrical discharge electrode according to claim 10, wherein:
the electrode material is copper tungsten;
wherein the step of annealing the electrode outline body is conducted in the vacuum at a temperature of 700° C. for 60 minutes.

12. The method of manufacturing an electrical discharge electrode according to claim 10, wherein:
the step of annealing the electrode outline body comprises a quenching step of performing a quenching under a nitrogen gas atmosphere after the annealing has been completed.

13. The method of manufacturing an electrical discharge electrode according to claim 12, wherein:
the nitrogen is liquid nitrogen evaporated into nitrogen gas which is brown into the vacuum for quenching.

14. An electrical discharge electrode, to be applied for manufacturing a honeycomb structure molding die, which is manufactured by the method defined in claim 1.
